(19) United States
(12) Patent Application Publication
(10) Pub. No.: US 2006/0184752 A1
(43) Pub. Date: Aug. 17, 2006

(54) Memory controller and memory control system predicting non-contiguous access

(75) Inventor: Hiroyuki Takano, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/282,656

(22) Filed: Nov. 21, 2005

(30) Foreign Application Priority Data
Feb. 3, 2005 (JP) 2005-027668

(51) Int. Cl. G06F 13/00

(52) U.S. Cl. 711/154

(57) ABSTRACT

A memory controller for controlling operation of a memory accessed by a processor, includes an access information storage circuit storing history information of non-contiguous access of non-contiguous addresses of data accessed by the processor, a prediction circuit predicting a non-contiguous access based on the history information of non-contiguous access, an address transmitter transmitting a read address of data read from the memory based on the prediction of the non-contiguous access, and a data storage circuit storing the data read from the memory based on the read address.

### CROSS REFERENCE TO RELATED APPLICATIONS AND INCORPOPATION BY REFERENCE

This application is based upon and claims the benefit of priority from prior Japanese Patent Application P2005-027668 filed on Feb. 3, 2005; the entire contents of which are incorporated by reference herein.

### BACKGROUND OF THE INVENTION

1. Field of the Invention

The present invention relates to a memory controller for controlling operation of a memory, particularly to a memory controller predicting non-contiguous access.

2. Description of the Related Art

When a processor accesses data stored in memory, the throughput can be decreased by using a memory controller for controlling data transfer between the processor and the memory. As used here ‘throughput’ is the delay from a time when a processor accesses a memory to a time when the processor acquires data from the memory. Accordingly, throughput is dependent on the number of cycles of a system clock (latency) from when the processor starts accessing the memory to when the memory begins to operate. Latency required for a memory read operation is hereafter referred to as ‘read latency’.

The following method has been used for decreasing the throughput. The read latency of the memory is ‘four’, and the width of a data bus between the memory controller and the memory is a width allowing transfer of four pieces of data. Hereafter, an address corresponding to data that can be transferred at once through the data bus is referred to as ‘address width’. In other words, an address width is four when the width of the data bus is four pieces of data. The memory controller may store four pieces of data read from the memory in accordance with the width of the data bus. While the processor is reading the data stored in the memory controller, the memory controller reads and stores the next four pieces of data from the memory that are predicted to be accessed by the processor. In this case, the data that the memory controller will read from the memory is data having an address contiguous to an address with which the processor is reading data from the memory controller at that time. Accordingly, the following requirements need to be satisfied, so that the throughput will be one.

(1) The processor reads all four pieces of data having contiguous addresses stored in the memory controller.

(2) The next data for the processor to access is four pieces of data having an address contiguous to an address with which the processor has just read data from the memory controller.

However, while the processor is reading the data stored in the memory controller, there are cases where the processor accesses data having non-contiguous addresses (hereafter, referred to as ‘non-contiguous access’). In the case of a non-contiguous access, the data stored in the memory controller is useless. Therefore, data must be read from the memory after a latency of four from the access point in time. As a result, throughput increases.

According to another method for decreasing throughput, cache memory is arranged between the processor and the memory. However, problems of an increase in power consumption and the circuit area arise.

If the processor does not issue an instruction for all clock cycles, there is a waste in operation time. ‘Instructions per cycle (IPC)’ is an index indicating the frequency that the processor issues instructions. There are often cases where a non-contiguous access occurs if there is a branch instruction. As a result, the IPC decreases. As a countermeasure, there is a method for arranging internal memory in the processor, which stores information having an address predicted to be accessed next by the processor. However, in order to increase the accuracy of predicting that address, a large internal memory needs to be provided in the processor. Therefore, power consumption and the area of the processor increase.

### SUMMARY OF THE INVENTION

An aspect of the present invention inheres in a memory controller for controlling operation of a memory accessed by a processor, including an access information storage circuit configured to store history information of non-contiguous access of non-contiguous addresses of data accessed by the processor; a prediction circuit configured to predict a non-contiguous access based on the history information of non-contiguous access; an address transmitter configured to transmit a read address of data read from the memory, based on the prediction of the non-contiguous access; and a data storage circuit configured to store the data read from the memory based on the read address.

Another aspect of the present invention inheres in a memory controller for a memory control system including a processor; a memory; and a memory controller including an access information storage circuit configured to store history information of non-contiguous access of non-contiguous addresses of data accessed by the processor, a prediction circuit configured to predict a non-contiguous access based on the history information of non-contiguous access, an address transmitter configured to transmit a read address of data read from the memory based on the prediction of the non-contiguous access, and a data storage circuit configured to store the data read from the memory based on the read address.

### BRIEF DESCRIPTION OF DRAWINGS

FIG. 1 is a schematic diagram showing a memory controller according to a first embodiment of the present invention;

FIG. 2 is a first timing chart describing an operation of the memory controller according to the first embodiment of the present invention;

FIG. 3 is a second timing chart describing an operation of the memory controller according to the first embodiment of the present invention;

FIG. 4 is a third timing chart describing an operation of the memory controller according to the first embodiment of the present invention; and

FIG. 5 is a schematic diagram showing a memory controller according to a second embodiment of the present invention.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

In the following descriptions, numerous specific details are set fourth such as specific signal values, etc. to provide a thorough understanding of the present invention. However, it will be obvious to those skilled in the art that the present invention may be practiced without such specific details. In other instances, well-known circuits have been shown in block diagram form in order not to obscure the present invention in unnecessary detail.

### FIRST EMBODIMENT

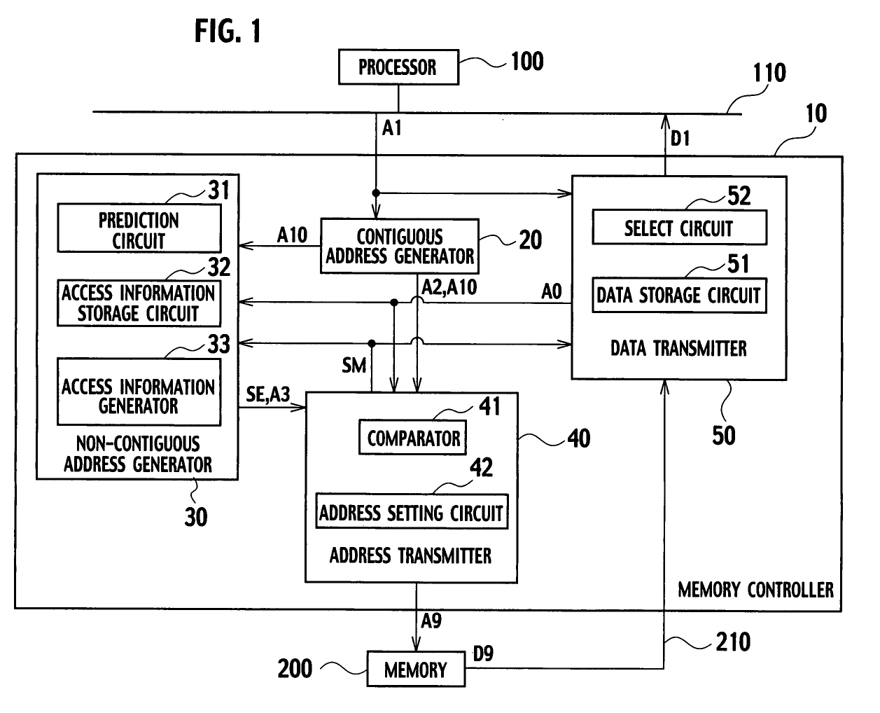

As shown in FIG. 1, a memory controller 10 according to the first embodiment of the present invention includes: an access information storage circuit 32, which stores history information of non-contiguous access of data having non-contiguous addresses accessed by the processor 100; a prediction circuit 31, which predicts a non-contiguous access based on the access information; an address transmitter 40, which transmits a read AW address A9 of data to be read from the memory 200 based on the predicted non-contiguous access; and a data storage circuit 51, which stores data D9 read from the memory 200, in the read AW address A9. The memory controller 10 controls an operation of memory 200 based on accesses by a processor 100. Explanation of “AW address” is described later.

As shown in FIG. 1, the prediction circuit 31, the access information storage unit 32 and an access information generator 33 are included in a non-contiguous address generator 30. The access information generator 33 generates history information of non-contiguous access. In addition, the memory controller 10 includes a contiguous address generator 20, which receives an access address A1 transmitted from the processor 100. The memory controller 10 further includes a data transmitter 50. The data transmitter 50 includes a data storage circuit 51 and a select circuit 52. The select circuit 52 selects data stored in the data storage circuit 51. The address transmitter 40 includes a comparator 41 and an address setting circuit 42.

The memory controller 10 is connected to the processor 100 via a bus 110. The memory controller 10 is also connected to the memory 200. The read latency of the memory 200 is n (where n is an integer of 2 or more).

The non-contiguous address generator 30, the address transmitter 40 and the bus 110 connect to the contiguous address generator 20. The non-contiguous address generator 30 and the memory 200 connect to the address transmitter 40. Furthermore, the non-contiguous address generator 30, the memory 200 and the bus 110 connect to the data transmitter 50.

Data D9 read from the memory 200 is transferred to the data storage circuit 51 via a data bus 210. The data storage circuit 51 stores data, the number of which corresponds to the width of the data bus 210. For example, the data storage circuit 51 stores four pieces of data when the width of the data bus 210 is four pieces of data. Accordingly, address width W of the data bus 210 is four. The width of the data bus 210 is set to be n or greater, where n is equal to the read latency of the memory 200. Therefore, in the case of a read latency n=4 of the memory 200, for example, the number of data stored in the data storage circuit 51 is set to four or greater. In other words, the number of data D9 stored in the data storage circuit 51 is four or more.

The contiguous address generator 20 generates an address predicted to be accessed by the processor 100 based on an access address A1 received from the processor 100. The ‘access address’ denotes an address of data that the processor 100 has accessed. The contiguous address generator 20 assumes that the processor 100 will access data stored in the data storage circuit 51 and data having an address contiguous thereto. The contiguous address generator 20 then predicts an address that the processor 100 will access based on that assumption.

While the processor 100 successively reads data stored in the data storage circuit 51, read operation of the memory 200 is carried out. The number of data stored in the data storage circuit 51 is equal to or greater than the value of the read latency of the memory 200. Consequently, after the processor 100 has read all the data stored in the data storage circuit 51, data D9 read from the memory 200 is stored in the data storage circuit 51. When the address width W is four, the number of data stored in the data storage circuit 51 is four. Consequently, the contiguous address generator 20 predicts an address of data requested by the processor after accessing four pieces of data in the access address A1, and generates an address. In other words, the address generated by the contiguous address generator 20 is generated by adding the address width W to the access address A1.

For example, when the number of data stored in the data storage circuit 51 is four, an address for four pieces of data is generated every four times the processor 100 provides an access address. In other words, the contiguous address generator 20 generates an address for four pieces of data to be stored in the data storage circuit 51 for every address counted in units of address width W. Addresses counted in units of address width W are referred to as ‘AW addresses’. For example, when the address width W is four, AW addresses are address m, address m+4 . . . (where m is an integer of zero or greater). In this case, in order to simplify the description, the address for the data stored in the memory 200 increases one by one. AW addresses predicted for read operation of the memory 200 are hereafter referred to as ‘storage AW addresses A2’.

By providing a storage AW address A2 to the memory 200, the number of data corresponding to the address width W is read from the memory 200. When the address width W is four pieces of data of address m, address m+1, address m+2, and address m+3 is read from the memory 200 by transmitting storage AW address A2=m to the memory 200.

Furthermore, the contiguous address generator 20 generates a request AW address A10, which is an AW address, based on the access address A1 provided from the processor 100 and the number of data stored in the data storage circuit 51. For example, if the access address A1 is either m, m+1, m+2 or m+3 when the address width W is four, the request AW address A10=m. Storage AW address A2 is an AW address that is contiguous to the request AW address A10. In other words, storage AW address A2=request AW address A10+W. The contiguous address generator 20 transmits the request AW address A10 and the storage AW address A2 to the address transmitter 40. In addition, the contiguous address generator 20 transmits the request AW address A10 to the prediction circuit 31.

The data transmitter 50 transmits data requested by the processor 100 to the processor 100, based on the access address A1 received from the processor 100. More specifically, the select circuit 52 selects data D1, which is requested by the processor 100 based on the access addresses A1, from among the data stored in the data storage circuit 51. The data transmitter 50 then transmits data D1 selected by the select circuit 52 to the processor 100. In addition, the data transmitter 50 transmits a start AW address A0 to the prediction circuit 31. The ‘start address’ denotes an AW address of data stored at the top of the data storage circuit 51. Furthermore, to improve throughput, the data transmitter 50 may transmit the data read from the memory 200 to the processor 100 without being stored in the data storage circuit 51. For example, the data transmitter 50 may be configured to directly transmit the data read from the memory 200 to the processor 100 in response to reception of a mismatch signal SM. As described later, the mismatch signal SM is transmitted from the comparator 41 when a non-contiguous access has occurred.

The access information storage circuit 32 stores a plurality of non-contiguous addresses set as access information. A non-contiguous address set is made up of a first address and a second address. A non-contiguous address set is generated by the access information generator 33 when a mismatch signal SM has been received. The first address in the non-contiguous address set is a start AW address A0 of data stored at the start of the data storage circuit 51 when a non-contiguous access has occurred. On the other hand, the second address in the generated non-contiguous address set is a request AW address A10 generated at a time when the non-contiguous access occurred. The second address is generated based on an address transmitted from the processor 100 and the number of data stored in the data storage circuit 51. The generated non-contiguous address set is stored in the access information storage circuit 32.

Furthermore, the prediction circuit 31 compares the start AW address A0 and a plurality of first addresses stored in the access information storage circuit 32. If the start AW address A0 and any one of the plurality of first addresses stored in the access information storage circuit 32 match, this means that a non-contiguous access to data, which is stored in the data storage circuit 51 at that time, has previously occurred. Therefore, when the start AW address A0 and any one of the plurality of first addresses stored in the access information storage circuit 32 match, the prediction circuit 31 transmits a prediction signal SE and a non-contiguous predicted AW address A3 to the address setting circuit 42. The non-contiguous predicted AW address A3 is the second address in the non-contiguous address set of which the first address matches the start AW address A0.

The request AW address A10 and the start AW address A0 are transmitted to the comparator 41. The comparator 41 compares the request AW address A10 and the start AW address A0. The comparator 41 transmits a mismatch signal SM to the access information generator 33 and the data transmitter 50 address transmitter 33 when the request AW address A10 and the storage AW address A0 fail to match. The mismatch signal SM is also transmitted to the address setting circuit 42.

The address setting circuit 42 sets a read AW address A9 to be transmitted to the memory 200 in the following manner based on whether or not it has received the prediction signal SE or the mismatch signal SM.

(1) When a prediction signal SE is not received and a mismatch signal SM is not received, the data being accessed by the processor 100 is included in the data stored in the data storage circuit 51. In other words, a non-contiguous access has not occurred. In that case, the address setting circuit 42 sets a storage AW address A2 as the read AW address A9.

(2) If a prediction signal SE is not received but the mismatch signal SM is received, this means that a non-contiguous access has failed to match the non-contiguous address set stored in the access information storage circuit 32. In that case, data being accessed by the processor 100 is not stored in the data storage circuit 51. Therefore, the address setting circuit 42 sets a request AW address A10 as the read AW address A9. Data D9 is then read from the memory 200 based on that read AW address A9. The processor 100 enters a wait state until data D9 is read. As a result, throughput is dependent on the read latency n of the memory 200. Upon reception of the mismatch signal SM, the data transmitter 50 can transmit data D9 to the processor 100 without storing it in a data storage device. As a result, the waiting time of the processor 100 can be decreased.

(3) When a prediction signal SE is transmitted from the prediction circuit 31 to the address setting circuit 42, the address setting circuit 42 sets the non-contiguous predicted AW address A3 transmitted from the prediction circuit 31 as the read AW address A9. Consequently, the next data to be stored in the data storage circuit 51 includes the data accessed by the processor 100 at the time when the non-contiguous access occurred. The data, stored in the data storage circuit 51 and not accessed by the processor 100 until the time of the non-contiguous access, is data not requested by the processor 100 after the non-contiguous access. Therefore, the processor 100 enters a wait state until the requested data is stored in the data storage circuit 51. However, a non-contiguous access is predicted to occur before that non-contiguous access, and read operation of the memory 200 starts, based on the non-contiguous predicted AW address A3. In other words, when the same non-contiguous access has occurred as before, reading the data requested by the processor 100 from the memory 200 starts at the time of the non-contiguous access. As a result, the data requested by the processor 100 is read from the memory 200 faster than when the data requested by the processor 100 is read from the memory 200 after the non-contiguous access. Namely, throughput is improved due to the memory controller 10 shown in FIG. 1.

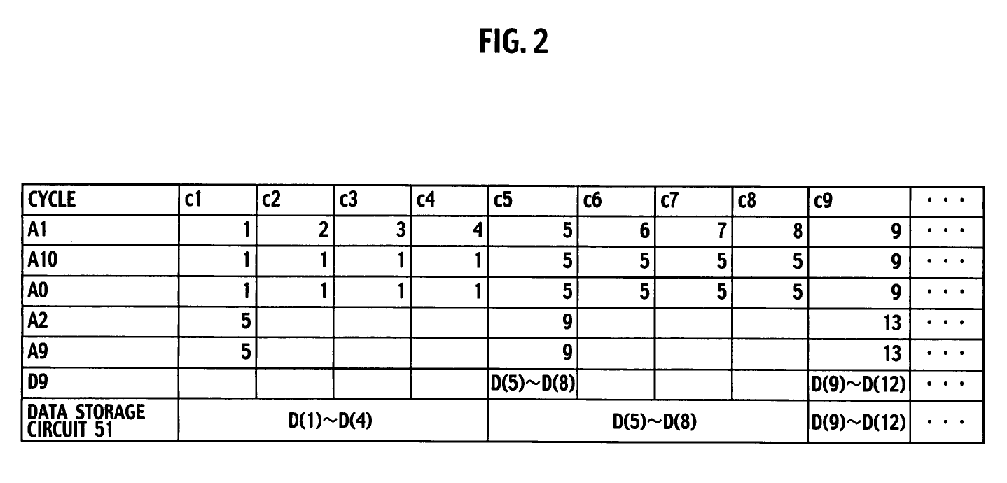

Operations of the memory controller 10 shown in FIG. 1 are described forthwith using exemplary timing charts of FIGS. 2 to 4. In the following description, the read latency n of the memory 200 is assumed to be four. In addition, addresses in the memory 200 are assumed to be one, two . . . . Data at address m is given as D(m). Furthermore, the width of the data bus 210 is four pieces of data, and the number of data stored in the data storage circuit 51 is four.

[Case of No Non-Contiguous Access]

The timing chart of FIG. 2 is an example of no non-contiguous access. In addition, it is assumed that a non-contiguous address set is not stored in the access information storage circuit 32.

In cycle c1, access address A1=1 is transmitted from the processor 100 to the memory controller 10. Data D(1), D(2), D(3) and D(4) are stored in the data storage circuit 51. As a result, data D(1) is transmitted from the data transmitter 50 to the processor 100 in cycle c2.

In cycle c1, since access address A1=1, request AW address A10=1, and storage AW address A2=5. The start AW address A0=1 since data D(1) to D(4) are stored in the data storage circuit 51. Therefore, a mismatch signal SM is not transmitted. In addition, since a non-contiguous address set is not stored in the access information storage circuit 32, a prediction signal SE is not transmitted. As a result, storage AW address A2 is transmitted to the memory 200 as a read AW address A9.

In cycles c2 to c4, access addresses A1=2 to 4, respectively. Since data D(1) to (4) are stored in the data storage circuit 51, a mismatch signal SM is not transmitted. Data D(2) to D(4) are transmitted to the processor 100 in cycles c3 to c5, respectively.

Since read AW address A9 is transmitted to the memory 200 in cycle c1, data D9 is read from the memory 200 in cycle c5. Since read AW address A9=5, data D9 corresponds to data D(5) to D(8). Accordingly, data D(5) to D(8) are stored in the data storage circuit 51. Since access address A1=5 in cycle c5, data D(5) is transmitted from the data storage circuit 51 to the processor 100 in cycle c6. Subsequently, request AW address A2=9 is transmitted from the address transmitter 40 to the memory 200 as read AW address A9. As a result, data D(9) to D(12) are read from the memory 200 in cycle c9. Meanwhile, data D(6) to D(8) are transmitted to the processor 100 according to access addresses A1=6 to 8 in cycles c6 to c8, respectively.

In the same manner, even after cycle c9, data having contiguous addresses are stored in the data storage circuit 51. Accordingly, data are transmitted from the data storage circuit 51 to the processor 100. As a result, a throughput of one is maintained.

[Case 1 of a Non-Contiguous Access]

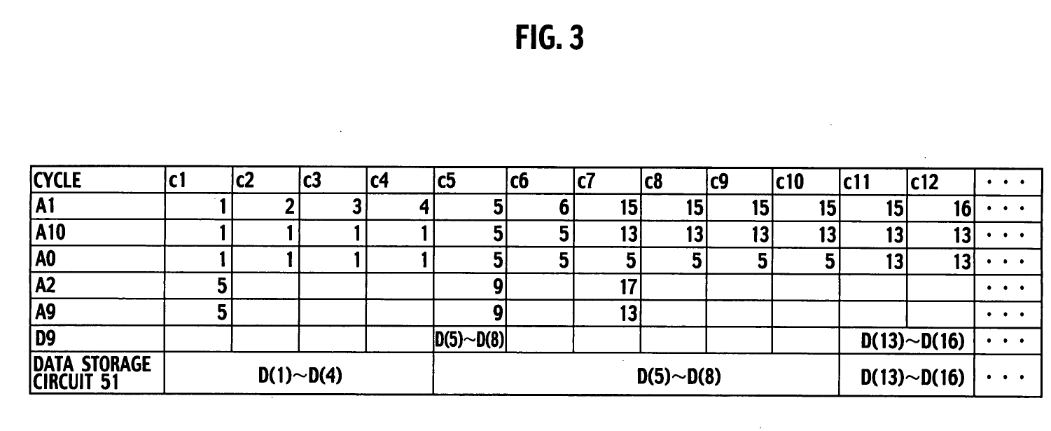

The timing chart of FIG. 3 is an example of a non-contiguous access. In addition, it is assumed that a non-contiguous address set is not stored in the access information storage circuit 32.

In cycles c1 to c4 shown in FIG. 3, access addresses A1=1 to 4, respectively. Therefore, memory controller operations in cycles c1 to c4 are the same as in the case described using the timing chart of FIG. 2. In other words, data D1 is transmitted from the memory controller 10 to the processor 100 in accordance with the access address A1 provided from the processor 100.

Read AW address A9=5 is transmitted to the memory 200 in cycle c1. Accordingly, data D(9) is read from the memory 200 in cycle c5. Data D(5) to D(8) are then stored in the data storage circuit 51. Since access address A1=5 in cycle c5, data D(5) is transmitted to the processor 100 in cycle c6. Furthermore, data D(6) is transmitted to the processor 100 in accordance with access address A1=6 in cycle c6.

In cycle c7, access address A1=15. In other words, a non-contiguous access occurs. Consequently, request AW address A10=13 and fails to match start AW address A0=5. Since data D(15) is not stored in the data storage circuit 51, the processor enters a data wait state.

Since the request AW address A10 and the start AW address 0 fail to match, the comparator 41 transmits a mismatch signal SM to the data transmitter 50, the access information generator 33, and the address setting circuit 42.

Since a non-contiguous address set is not stored in the access information storage circuit 32, a prediction signal SE is not transmitted. Therefore, the address setting circuit 42 transmits the request AW address A10 as read AW address A9. As a result, data D(9) is read from the memory 200 in cycle c11. Data D(13) to D(16) are then stored in the data storage circuit 51. As shown in FIG. 3, data D(15) is transmitted to the processor 100 in cycle c11. In addition, the data transmitter 50 can transmit data D9 to the processor 100 without storing it in the data storage circuit 51. The waiting time of the processor 100 can be decreased as a result.

On the other hand, the access information generator 33 that has received the mismatch signal SM generates a non-contiguous address set. The first address in the generated non-contiguous address set is start AW address A0=5 in cycle c7. On the other hand, the second address in the generated non-contiguous address set is request AW address A10=13 in cycle c7. The generated non-contiguous address set is stored in the access information storage circuit 32.

[Case 2 of a Non-Contiguous Access]

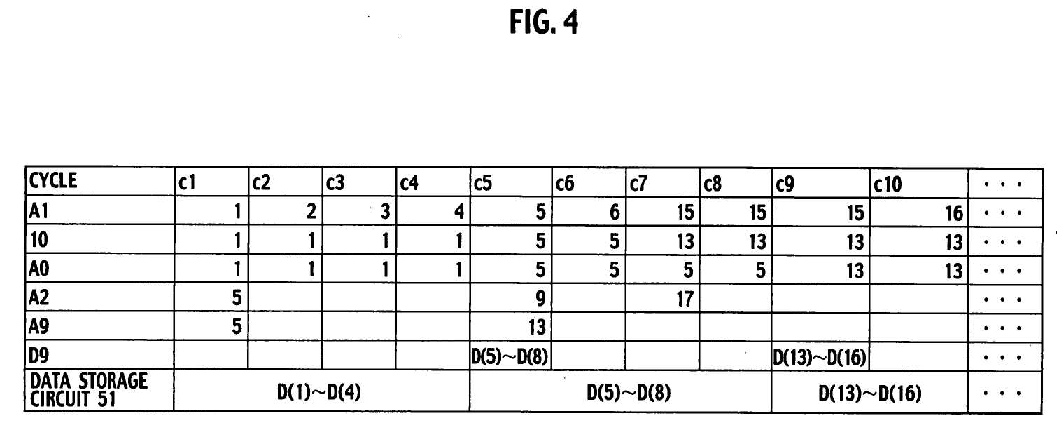

The timing chart of FIG. 4 is an example of a non-contiguous access. In addition, it is assumed that a generated non-contiguous address set shown in FIG. 4 is stored in the access information storage circuit 32. In other words, the non-contiguous address set, which has a first address=5 and a second address=13, is stored in the access information storage circuit 32.

In cycles c1 to c4 shown in FIG. 4, access addresses A1=1 to 4, respectively. Therefore, memory controller operations in cycles c1 to c4 are the same as in the case described using the timing chart of FIG. 2. In other words, data D1 is transmitted from the memory controller 10 to the processor 100 in accordance with the access address A1 transmitted from the processor 100.

Read AW address A9=5 is transmitted to the memory 200 in cycle c1. As a result, data D(9) is read from the memory 200 in cycle c5. Data D(5) to D(8) are then stored in the data storage circuit 51. Since access address A1=5 in cycle c5, data D(5) is transmitted to the processor 100 in cycle c6.

In cycle c5, start AW address A0=5. Therefore, the first address=5 and the second address=13 stored in the access information storage circuit 32 match the first address of the non-contiguous address set. As a result, the prediction circuit 31 transmits a prediction signal SE and non-contiguous predicted AW address A3 to the address setting circuit 42. Non-contiguous predicted AW address A3=13.

The address setting circuit 42 that received the prediction signal SE transmits the non-contiguous predicted AW address A3 to the memory 200 as read AW address A9. As a result, read operation of the memory 200 starts at cycle c5 based on the read AW address A9=13. Next, data D(6) is transmitted to the processor 100 in accordance with access address A132 6 in cycle c6.

In cycle c7, access address A1=15. In other words, the same non-contiguous access as that described using the timing chart of FIG. 3 occurs. Since data D(15) is not stored in the data storage circuit 51, the processor enters a wait state. However, the non-contiguous access is predicted and then read operation of the memory 200 starts at cycle c5. Consequently, data D(9) is transmitted from the memory 200 in cycle c9. As a result, in cycle c9, data D(15) is transmitted from the data storage circuit 51 to the processor 100. In other words, throughput is improved more than with the example of FIG. 3.

In the example of FIG. 4, there are cases where a non-contiguous access does not occur in cycle c7 even if start AW address A0=5. In other words, a non-contiguous access does not occur even if the prediction circuit 31 transmits a prediction signal SE. For example, when the processor 100 carries out a looping operation using the data stored in the memory 200, the same non-contiguous access is repeated. A non-contiguous access does not occur when the loop operation is completed. It can be understood that a non-contiguous access has not occurred since a mismatch signal SM is not transmitted from the comparator 41. When a prediction signal SE is received but a mismatch signal SM is not received, the address setting circuit 42 transmits request AW address A10 as read AW address A9 to the memory 200. Furthermore, when the prediction circuit 31 transmits a prediction signal SE and the comparator 41 does not transmit a mismatch signal SM, the memory controller 10 may be set so that the referred non-contiguous address set is deleted from the access information storage circuit 32.

However, an increase in circuit area and electrical power consumption of the access information storage circuit 32 is necessary for unlimited storage of non-contiguous address sets. As a result, the circuit area and electrical power consumption of the memory controller 10 are increased. Therefore, it is desirable to limit the number of non-contiguous address sets stored in the access information storage circuit 32. In that case, in order to store a new non-contiguous access set in the access information storage circuit 32, a non-contiguous access set stored in the access information storage circuit 32 must be deleted. For example, the first stored non-contiguous address set is deleted from the non-contiguous address sets stored in the access information storage circuit 32. Alternatively, the oldest non-contiguous address set in all the non-contiguous address sets stored in the access information storage circuit 32 with start AW address A0 matching the first address is deleted.

As described above, the memory controller, according to the first embodiment of the present invention, predicts a non-contiguous access, which allows start of the read operation requested by the processor 100 during the non-contiguous access, from the memory 200 before the non-contiguous access occurs. This improves throughput when a non-contiguous access has occurred. In other words, a reduction in the time necessary for acquiring the data stored in the memory 200 is possible. Furthermore, according to the memory controller of the first embodiment of the present invention, information of addresses instead of data is stored in the access information storage circuit 32. Therefore, the circuit area and electrical power consumption can be less than such characteristics of a circuit having cache memory or the like, which stores data in advance when a non-contiguous access occurs.

### SECOND EMBODIMENT

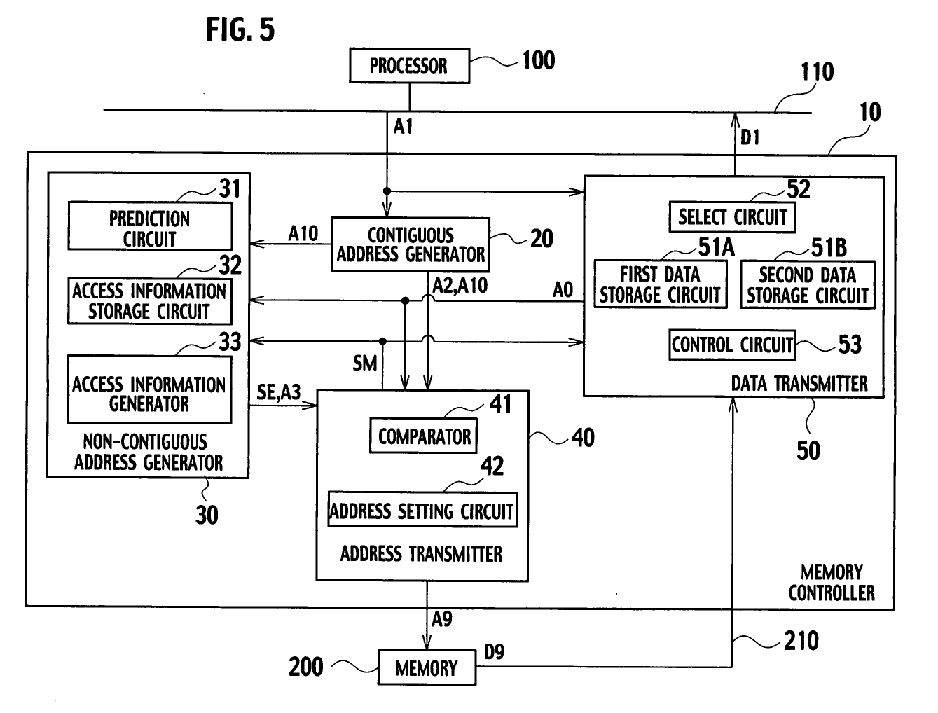

As shown in FIG. 5, a memory controller, according to the second embodiment of the present invention, is different from the memory controller 10 shown in FIG. 1 in that it includes a first data storage circuit 51A, a second data storage circuit 51B, and a control circuit 53. The rest of the structure is the same as with the first embodiment shown in FIG. 1.

An example of the processor 100 reading data D1 from the memory controller 10 in each cycle is given in the description of the memory controller shown in FIG. 1. However, there may be a cycle in which the processor 100 does not read data D1 from the memory controller 10. In that case, all of the data stored in the data storage circuit 51 is not read from the processor 100 even though data D9 is read from the memory 200. Therefore, if data D9 is stored in the data storage circuit 51, data stored in the data storage circuit 51 that is not read by the processor 100 is overwritten.

However, according to a memory controller 10A shown in FIG. 5, data D9 read from the memory 200 may be stored in the second data storage circuit 51B while data stored in the data storage circuit 51A is being transmitted to the processor 100. Alternatively, data D9 read from the memory 200 may be stored in the first data storage circuit 51A while data stored in the data storage circuit 51B is being transmitted to the processor 100.

The control circuit 53 controls operations of the first data storage circuit 51A and the second data storage circuit 51B. For example, when data D9 is read from the memory 200 while data D1 is being transmitted from the first data storage circuit 51A to the processor 100, the control circuit 53 can detect that all of the data stored in the first data storage circuit 51A is not transmitted to the processor 100. In that case, the control circuit 53 stores data D9 in the second data storage circuit 51B. When the control circuit 53 detects that all of the data stored in the first data storage circuit 51A has been transmitted to the processor 100, the next data requested by the processor 100 is transmitted from the second data storage circuit 51B to the processor 100. The rest of the operation is effectively the same as with the first embodiment, and thus duplicate descriptions are omitted.

According to the memory controller in the second embodiment, data D9 read from the memory 200 can be stored in the first data storage circuit 51A or the second data storage circuit 51B, even if there is a cycle in which the processor 100 does not read data D1 from the memory controller 10A.

### OTHER EMBODIMENTS

In the descriptions of the first and the second embodiment described above, examples are given where the processor 100 is connected to the memory controller 10 via the bus 110; however, the processor 100 may be directly connected to the memory controller 10.

Various modifications will become possible for those skilled in the art after receiving the teachings of the present disclosure without departing from the scope thereof.

What is claimed is:

1. A memory controller for controlling operation of a memory accessed by a processor, comprising:
an access information storage circuit configured to store a history information of non-contiguous access of non-contiguous addresses of data accessed by the processor;
a prediction circuit configured to predict a non-contiguous access based on the history information of non-contiguous access;
an address transmitter configured to transmit a read address of data read from the memory, based on the prediction of the non-contiguous access; and
a data storage circuit configured to store the data read from the memory based on the read address.

2. The memory controller of claim 1, wherein the history information is non-contiguous address set including a first address, which is a start address of data stored at the start of the data storage circuit when the non-contiguous access has occurred, and a second address, which is a request address generated based on an address transmitted from the processor and the number of data stored in the data storage circuit.

3. The memory controller of claim 2, wherein the prediction circuit predicts the non-contiguous access when a start address of data stored at the start of the data storage circuit and one of a plurality of the first address stored in the access information storage circuit match.

4. The memory controller of claim 3, wherein the prediction circuit transmits a prediction signal and a non-contiguous predicted address to the address transmitter when the non-contiguous access has been predicted.

5. The memory controller of claim 4, wherein the non-contiguous predicted address is the second address of the non-contiguous address set, which includes the first address that matches the start address at the time when the non-contiguous access has been predicted.

6. The memory controller of claim 5, further comprising:
a contiguous address generator configured to generate the request address based on an address transmitted from the processor and the number of data stored in the data storage circuit;
a comparator configured to compare the start address and the request address, and to transmit a mismatch signal when the start address and the request address fail to match; and
an address setting circuit configured to set the read address in accordance with the prediction signal and the mismatch signal.

7. The memory controller of claim 6, wherein the address setting circuit sets the request address as the read address upon receipt of the prediction signal but has failed to receive the mismatch signal.

8. The memory controller of claim 6, wherein the address setting circuit sets as the read address a storage address, which is contiguous to the request address, when having failed to receive one of the prediction signal and the mismatch signal.

9. The memory controller of claim 6, wherein the address setting circuit sets the request address as the read address when having failed to receive the prediction signal but having received the mismatch signal.

10. The memory controller of claim 6, wherein the address setting circuit sets the non-contiguous predicted address as the read address when having received the prediction signal and the mismatch signal.

11. The memory controller of claim 6, further comprising an access information generator configured to generate the access information upon receipt of the mismatch signal.

12. The memory controller of claim 1, wherein the number of data stored in the data storage circuit is at least equal to a latency necessary for read operation of the memory.

13. The memory controller of claim 1, wherein a number of data storable in the data storage circuit is stored in the data storage circuit after the processor reads all the data from the data storage circuit.

14. The memory controller of claim 1, further comprising
a select circuit configured to select data to be transmitted to the processor from among data stored in the data storage circuit, based on an address transmitted from the processor.

15. The memory controller of claim 1, further comprising at least one data storage circuit configured to store data read from the memory, based on the read address.

16. The memory controller of claim 15, further comprising a control circuit configured to control operations of a plurality of the data storage circuits.

17. The memory controller of claim 16, wherein the control circuit stores the data read from the memory in the data storage circuit from which all stored data is transmitted to the processor.

18. A memory control system comprising:
a processor;
a memory; and
a memory controller including:
an access information storage circuit configured to store history information of non-contiguous access of non-contiguous addresses of data accessed by the processor;
a prediction circuit configured to predict a non-contiguous access based on the history information of non-contiguous access;
an address transmitter configured to transmit a read address of data read from the memory, based on the prediction of the non-contiguous access; and
a data storage circuit configured to store the data read from the memory based on the read address.

19. The system of claim 18, wherein the history information is non-contiguous address set including a first address, which is a start address of data stored at the start of the data storage circuit when the non-contiguous access has occurred, and a second address, which is a request address generated based on an address transmitted from the processor and the number of data stored in the data storage circuit.

20. The system of claim 19, wherein the prediction circuit predicts the non-contiguous access when a start address of data stored at the start of the data storage circuit and one of a plurality of the first address stored in the access information storage circuit match.
